(19) United States
(12) Patent Application Publication
(10) Pub. No.: US 2010/0063970 A1
(43) Pub. Date: Mar. 11, 2010

(54) METHOD FOR MANAGING AND PROCESSING INFORMATION OF AN OBJECT FOR PRESENTATION OF MULTIPLE SOURCES AND APPARATUS FOR CONDUCTING SAID METHOD

(76) Inventor: Chang Hyun Kim, Seoul (KR)

Correspondence Address: LEE, HONG, DEGERMAN, KANG & WAIMEY, 660 S. FIGUEROA STREET, Suite 2300, LOS ANGELES, CA, 90017, US

(21) Appl. No.: 12/301,461

(22) PCT Filed: May 18, 2007
(86) PCT No.: PCT/KR2007/002427

§ 371 Date: Jul. 2, 2009

Related U.S. Application Data
(60) Provisional application No. 60/801,708, filed on May 19, 2006.
(60) Provisional application No. 60/803,214, filed on May 25, 2006.

(51) Int. Cl. G06F 17/30; G06F 15/16

(52) U.S. Cl. 707/741; 709/219; 707/E17.002; 707/E17.009; 707/E17.101; 707/E17.01; 707/E17.032

(57) ABSTRACT

When preparing meta data for a stored arbitrary content, the present method creates meta data including protocol information and access location information of the arbitrary content, creates an item for an auxiliary content that shall be played in synchronization with the arbitrary content, and incorporates identifying information of the item into the meta data. Further, information on language data of the auxiliary content is written in the created item. auxiliary item

### 1. TECHNICAL FIELD

The present invention relates to a method and apparatus for managing information about content sources stored in an arbitrary device on a network, e.g., a network based on UPnP and processing information among network devices according to the information.

### 2. BACKGROUND ART

People can make good use of various home appliances such as refrigerators, TVs, washing machines, PCs, and audio equipments once such appliances are connected to a home network. For the purpose of such home networking, UPnP™ (hereinafter, it is referred to as UPnP for short) specifications have been proposed.

A network based on UPnP consists of a plurality of UPnP devices, services, and control points. A service on a UPnP network represents a smallest control unit on the network, which is modeled by state variables.

A CP (Control Point) on a UPnP network represents a control application equipped with functions for detecting and controlling other devices and/or services. ACP can be operated on an arbitrary device which is a physical device such as a PDA providing a user with a convenient interface.

As shown in FIG. 1, an AV home network based on UPnP comprises a media server (MS) 120 providing a home network with media data, a media renderer (MR) 130 reproducing media data through the home network and a control point (CP) 110 controlling the media server 120 and media renderer 130. The media server 120 and media renderer 130 are devices controlled by the control point 110.

The media server 120 (to be precise, CDS 121 (Content Directory Service) inside the server 120) builds beforehand information about media files and containers (corresponding to directories) stored therein as respective object information (also called as ‘meta data’ of an object). ‘Object’ is a terminology encompassing items carrying information about more than one media source, e.g., media file and containers carrying information about directories; an object can be an item or container depending on a situation. And a single item may correspond to multiple media sources, e.g., media files. For example, multiple media files of the same content but with a different bit rate from each other are managed as a single item.

Meanwhile, a single item may have to be presented along with and in synchronization with another component, item or media source. (Two or more media sources that have to be presented synchronously each other are called ‘multiple sources’ or ‘multi sources’.) For example, in the event that a media source is a movie title and another media source is subtitle (also called ‘caption’) of the movie title, the two media sources are preferably to be presented synchronously.

For such synchronous presentation, meta data of an object, i.e., an item created for such a media source has to store necessary information.

### 3. DISCLOSURE OF THE INVENTION

The present invention is directed to structure information about items in order for media sources to be presented in association with each other to be presented exactly and provide a signal processing procedure according to the structured information and an apparatus carrying out the procedure.

A method for preparing meta data about stored content according to the present invention comprises creating meta data including protocol information and access location information about an arbitrary content; creating an item of an auxiliary content to be presented in synchronization with the arbitrary content and writing information on text data of the auxiliary content in the created item; and incorporating identification information of the created item into the meta data.

Another method for preparing meta data about stored content according to the present invention comprises creating meta data including protocol information and access location information about an arbitrary content whose attribute is video and/or audio; and writing in the meta data information on language of text data included in the arbitrary content.

An apparatus for making presentation of a content according to the present invention comprises a server storing at least one main content and at least one item corresponding to an auxiliary content that is to be presented in synchronization with the main content; a renderer for making presentation of the main content and the auxiliary content provided from the server, wherein the renderer includes a first state variable for storing language information of text data to be presented when the text data contained in the auxiliary content is presented.

In embodiments according to the present invention, the text data is language data or subtitle (caption) data.

In one embodiment according to the present invention, a single item or a plurality of items are created for the auxiliary content to be presented in synchronization with the arbitrary content.

In another embodiment according to the present invention, if a plurality of items are created for an auxiliary content, the items are respectively corresponding to media sources that have data of mutually different languages.

In another embodiment according to the present invention, a single item is created for a single media source containing caption data of a plurality of languages.

In another embodiment according to the present invention, a single item is created for a plurality of media sources needed for presentation of a single language.

In one embodiment according to the present invention, the information on text data and the information on language of text data respectively include information indicative of language displayed during playing and character code information indicative of a character set used for language displaying.

In one embodiment according to the present invention, the identification information is written in a tag other than another tag where protocol information and access location information are written.

In one embodiment according to the present invention, the information on text data and the information on language of text data are written as attribute information of a tag where protocol information and access location information are written.

In one embodiment according to the present invention, the first state variable includes a state variable indicative of language displayed during presentation of text data and another state variable indicative of a character set used for language displaying.

In one embodiment according to the present invention, the renderer further comprises a second state variable for storing a list of languages whose rendering is possible.

In one embodiment according to the present invention, a third state variable indicating whether or not to present caption data contained in the auxiliary content is further included.

In one embodiment according to the present invention, value of the first, second and/or third state variable is changed or queried by a state variable setting action or a state variable query action received from outside of the renderer.

### 4. BRIEF DESCRIPTION OF THE DRAWINGS

FIG. 1 illustrates a general structure of a UPnP AV network;

FIG. 2 illustrates structuring of item information for a content having an associated auxiliary content and networked devices carrying out signal processing among devices;

FIG. 3 illustrates a signal flow, carried out on the network of FIG. 2, among devices for playing associated contents together;

FIGS. 4A to 4F illustrate simplified structures of item information according to an embodiment of the present invention, each of the structures including information about a main content and an auxiliary content to be presented in association with the main content;

FIG. 5 illustrates attribute information and a tag that are defined and used for preparation of meta data by a content directory service installed in a media server of FIG. 2 according to an embodiment of the present invention;

FIG. 6 illustrates state variables that are defined and used for supporting presentation of caption data by a rendering control service installed in a media renderer of FIG. 2 according to an embodiment of the present invention; and

FIG. 7 illustrates an information window provided for user's selection when there is an auxiliary content to be reproduced in association with a selected main content.

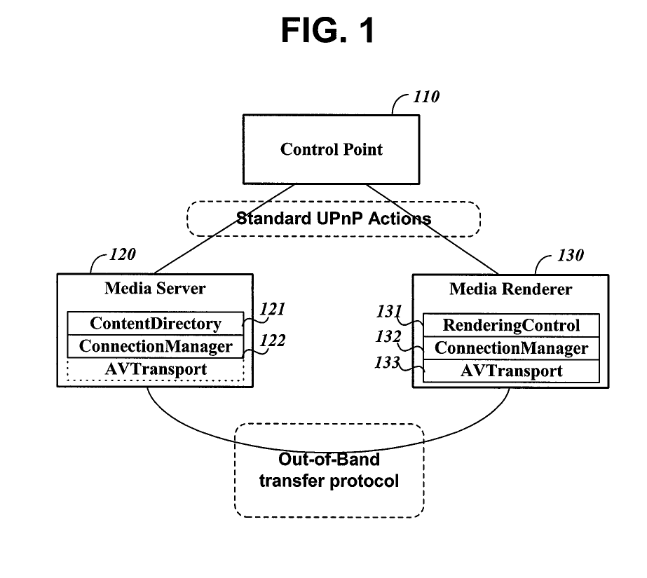

### 5. BEST MODE FOR CARRYING OUT THE INVENTION

Hereinafter, according to the present invention, preferred embodiments of a method for managing and processing information of an object for presentation of multiple sources and apparatus for conducting said method will be described in detail with reference to appended drawings.

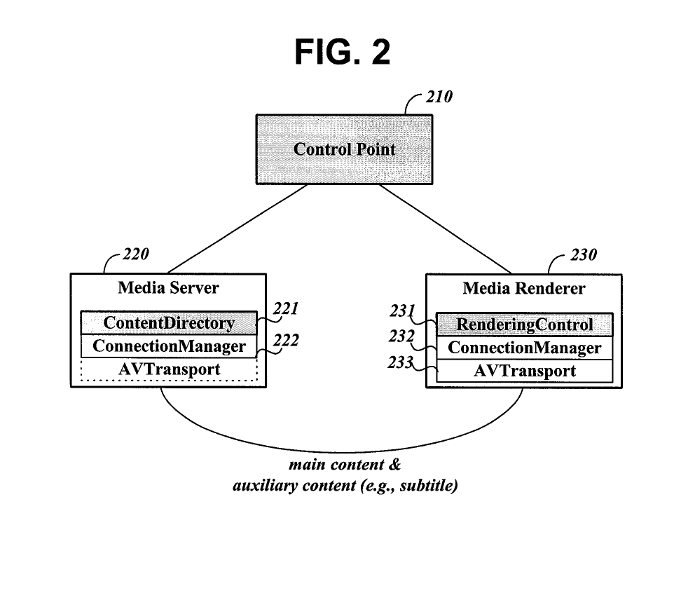

FIG. 2 illustrates a simplified example of structuring item information for a content having an associated content and networked devices carrying out signal processing between devices. The network shown in FIG. 2 is an AV network based on UPnP, including a control point 210, a media server 220, and a media renderer 230. Although description on the present invention is given to networked devices based on UPnP standard, what are described in the following can be directly applied to other network standards by adaptively substituting necessary elements with regard to differences of the standards where the present invention may apply. In this regard, therefore, the present invention is not limited to a network based on UPnP.

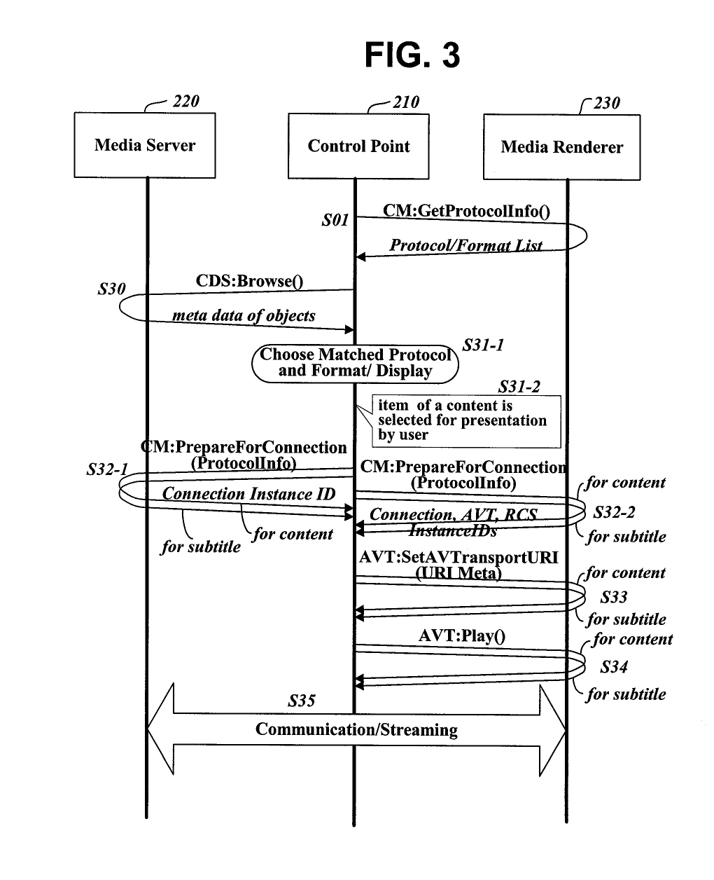

Structuring item information for multiple sources according to the present invention is conducted by CDS 221 within the media server 220. Signal processing for multiple sources according to the present invention is an example, which is carried out according to the illustrated procedure of FIG. 3 centering on the control point 210.

Meanwhile, composition of devices and procedure of signal processing illustrated in FIGS. 2 and 3 are related to one of two different modes for streaming a media source, namely, pull mode between push and pull modes. However, difference between push and pull modes lies only in the fact that a device equipped with AVTransport service for playback management of streaming or an employed device can be varied and subsequently the direction of an action can be varied according to whether the object of the action is a media server or media renderer. Therefore, methods for conducting actions described in the following can be adaptively (e.g., changing action target) applied if push mode, and interpretation of the claimed scope of the present invention is not limited to those methods illustrated in the figures and description.

A CDS 221 within the media server 220 (which may be a processor executing software) prepares item information about media sources, namely meta data about each source or a group of sources in the form of a particular language through searching and examining media files stored in a mass storage such as a hard disk. At this time, a main content of video and an auxiliary content thereof, e.g., caption or subtitle files storing text data for displaying captions or subtitles are all considered as a single content and single item information is created. Or, item information is created for each of a main content and an auxiliary content, and link information is written in either item information. Not to mention, a plurality of items may be created for an auxiliary content as the need arises.

Meanwhile, the CDS 221 determines inter-relation among respective media files and which is a main content or auxiliary content from, e.g., the name and/or extension of each file. If necessary, information about properties of each file, whether the file is a text or image and/or coding format can also be determined from the extension of the corresponding file. Also, if needed, the above information can be identified from header information within each file by opening the corresponding file; further, the above information can be easily obtained from a DB about pre-created files (by some other application programs) for stored media files, which is stored in the same medium. Moreover, the CDS 221 may prepare the above information based on relationship between files, designations of media files to a main or auxiliary content and format information of data encoding that are given by a user.

Hereinafter, a method for preparing item information for a main content and/or an auxiliary content is described in detail.

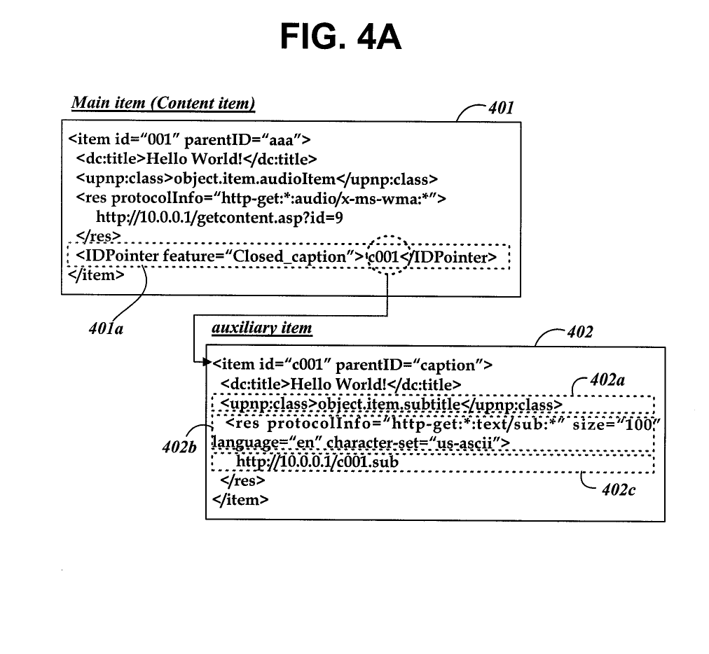

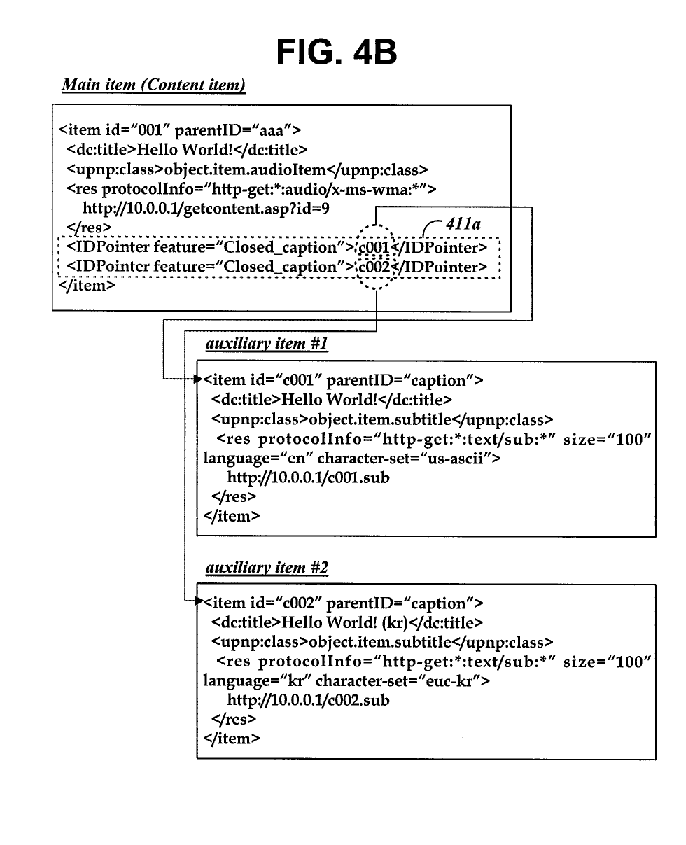

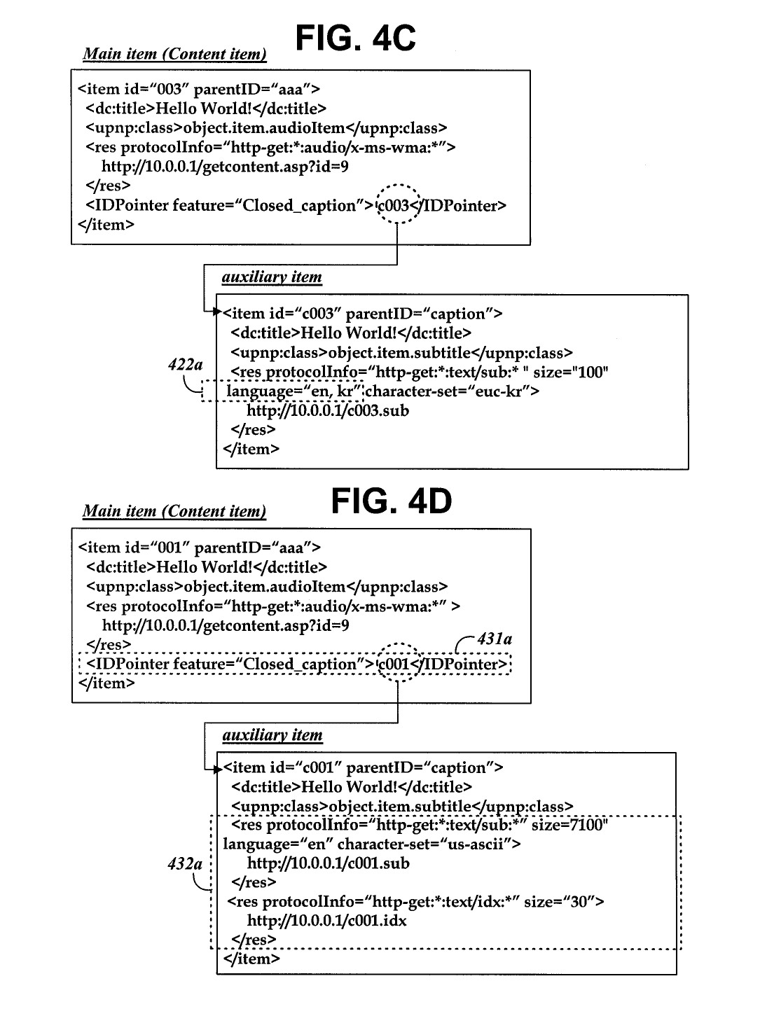

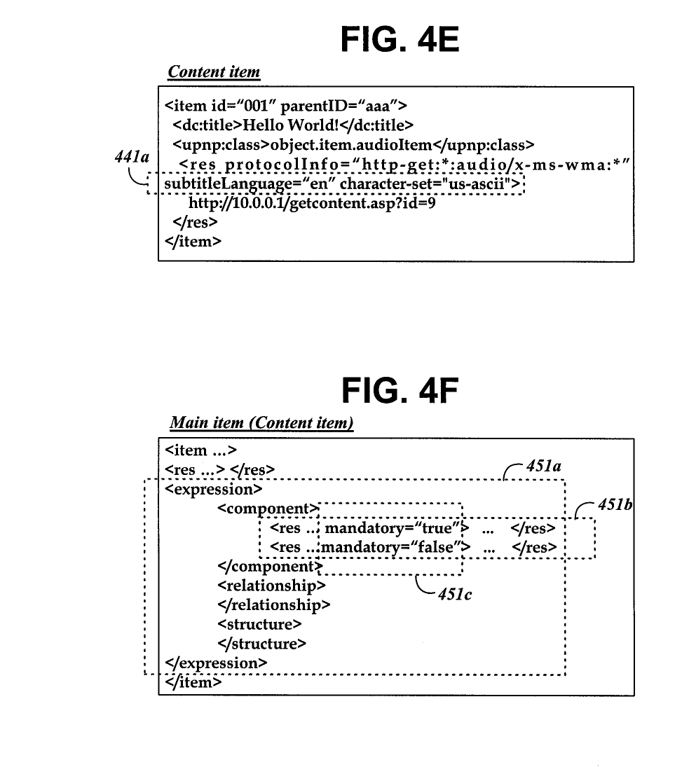

FIG. 4A illustrates structure of item information according to an embodiment of the present invention.

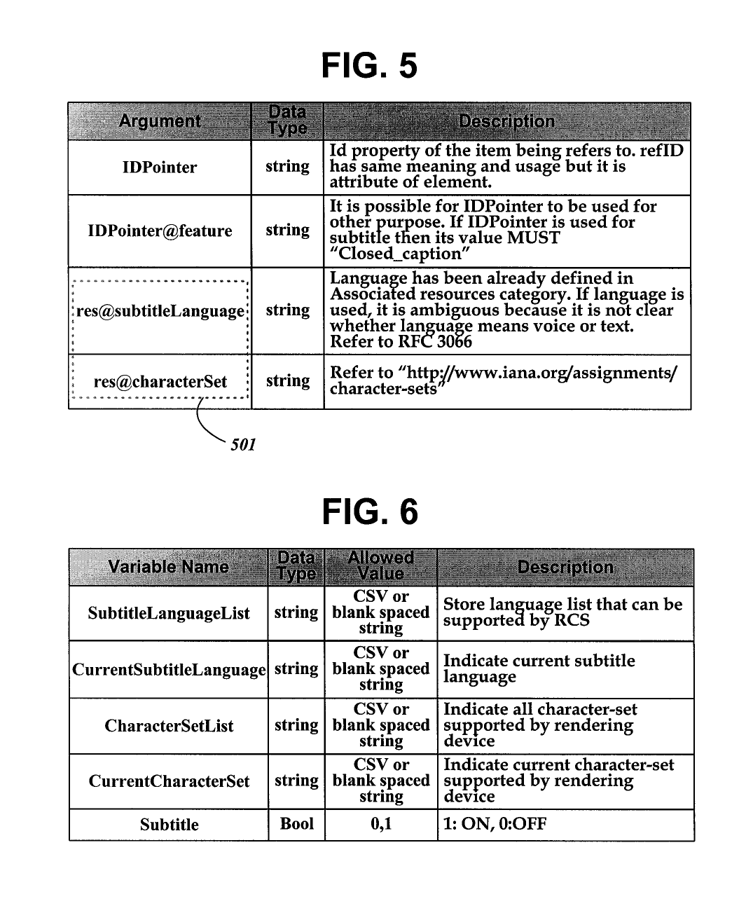

The information structure of an item illustrated in FIG. 4A that is prepared according to an embodiment of the present invention is for a case that a single item of an auxiliary content is associated with a main content. As shown, a single item having an identification of “c001” is created for the auxiliary content, and meta data of the item includes information on class 402a of the auxiliary content (The designated class text “object. item. subtitle” indicates caption.), protocol information and information on caption 402b (e.g., information indicative of language of caption, a character set for displaying caption data, etc.) for a media source of the auxiliary content, and protocol information for enabling acquisition of a media file storing actual data of auxiliary content and access location information 402c, e.g., URL information of the media file. A variety of information is written in the meta data besides the mentioned information, however, explanation about such information is omitted because it is not related to the present invention. For preparing the above-mentioned text data, more particularly caption data, the CDS 221 defines and uses attribute information 501 of a resource tag <res> that has properties illustrated in FIG. 5.

Protocol information for enabling acquisition of a media source corresponding to a main content and access location information, e.g., URL information are written, using a resource tag <res>, in meta data 401 of an item having an identification of “001” corresponding to the main content. For linking to the auxiliary content associated with the main content, an identification 401a capable of identifying an item of the auxiliary content is also written using a tag <IDPointer> defined as a property illustrated in FIG. 5. The tag can be named differently from the illustrated one.

In the embodiment of FIG. 4A, a value “Closed_caption” is assigned to an attribute ‘feature’ defined as an attribute of the tag <IDPointer> as shown FIG. 5. Not to mention, the assigned value is only an example and the present invention does not necessarily require the attribute ‘feature’ for the tag for linking to auxiliary content. The ‘Closed_caption’, value of the attribute ‘feature’, means that caption data can be displayed only in case of execution of caption data decoding or caption activation. A contrary value ‘Open_caption’ may be set to the attribute ‘feature’. In the example of FIG. 4A, the main content obtained from a URL “http://10.0.0.1/getcontent.asp?id=9” is linked to a media source, i.e., a media file designated by a URL “http://10.0.0.1/c001.sub”.

FIG. 4B illustrates structure of item information according to another embodiment of the present invention.

The information structure of an item illustrated in FIG. 4B that is prepared according to an embodiment of the present invention is for a case that a plurality of items of an auxiliary content are associated with a main content. In the present embodiment, the items of the auxiliary content have caption data of mutually different languages.

That is, meta data of an item having an identification of “c001” shows that caption language of corresponding item is English (language=“en”) while meta data of another item having an identification of “c002” shows that caption language of corresponding item is Korean (language=“kr”). Linking information to each of the items is written in each tag <IDPointer> 411a of meta data of a main content whose identification is “001”.

FIG. 4C illustrates structure of item information according to another embodiment of the present invention.

The information structure of an item illustrated in FIG. 4C that is prepared according to an embodiment of the present invention is for a case that a single item of an auxiliary content is associated with a main content. In the present embodiment, a media source corresponding to the single item has media data of mixed attributes. In other words, the main content is linked to a single item for a single media source containing a plurality of caption data groups that have caption data of mutually different languages.

Therefore, in a different way from the embodiment of FIG. 4A, meta data of the item having an identification of “c003” corresponding to the auxiliary content shows, through attribute information 422a (language=“en, kr”) of a resource tag <res> where information on a source is written, that caption data groups of English and Korean are contained together in a media file to be obtained based on a written URL “http://10.0.0.1/c003.sub”.

FIG. 4D illustrates structure of item information according to another embodiment of the present invention.

The information structure of an item illustrated in FIG. 4D that is prepared according to an embodiment of the present invention is for a case that a single item of an auxiliary content is associated with a main content. In the present embodiment, the single item of the auxiliary content is corresponding to a plurality of media sources. The information structure of an item according to the present embodiment is adopted in the event that a plurality of media sources are needed for successful presentation of an auxiliary content. On the contrary, the media source pointed by each of items of an auxiliary content prepared in accordance with the embodiment of FIG. 4B can be successfully presented alone in synchronization with a main content.

As shown in FIG. 4D, meta data of an item having an identification of “c001” corresponding to an auxiliary content includes, in respective resource tags 432a within a single item, a URL “http://10.0.0.1/c001.sub” of a media source containing actual caption data whose language is English (language=“en”) and another URL “http://10.0.0.1/c001.idx” of a file containing sync information needed for presentation of the actual caption data in synchronization with a main content.

Linking information to the item is written in a tag <IDPointer> 431a of meta data of the main content whose identification is “001”.

In the above-explained embodiments of FIGS. 4A to 4D, an item is created for a media source or media source combination of a minimal unit that is successfully presented in synchronization with a main content and the created item is then linked to an item of the main content. Explaining in more detail, an item is created for a media source “http://10.0.0.1/c001.sub” in the embodiment of FIG. 4A because that source is enough for successful presentation of English caption, two items are created respectively for both media sources “http://10.0.0.1/c001.sub” and “http://10.0.0.1/c002.sub” in the embodiment of FIG. 4B because said both sources are independently enough for normal presentation of English or Korean caption, an item is created for a media source “http://10.0.0.1/c001.sub” in the embodiment of FIG. 4C because that source is enough for presentation of either English or Korean caption and can not divided for each language, and an item is created for combination of the media sources “http://10.0.0.1/c001.sub” and “http://10.0.0.1/c001.idx” in the embodiment of FIG. 4D because data of the two media sources is needed together for synchronous presentation with a main content.

FIG. 4E illustrates structure of item information according to another embodiment of the present invention.

The information structure of an item illustrated in FIG. 4E that is prepared according to an embodiment of the present invention is for a case that data of an auxiliary content to be presented in synchronization with a main content is also stored in a media source of the main content. In such case, the main content and the auxiliary one can not be distinguished by media source and information on the auxiliary content is written in a resource tag as attribute value in meta data of an item of one content.

As illustrated in FIG. 4E, the fact that language is English and a character set is coded in US-ASCII scheme is written in a resource tag of a target content as attribute for a subtitle 441a besides a URL “http://10.0.0.1/getcontent.asp?id=9” about a content source.

FIG. 4F illustrates structure of item information according to another embodiment of the present invention.

In the present embodiment, an auxiliary content exists as a media source separated from a source of main content and information on each media source of the auxiliary content is written as a resource tag within a tag <component> 451b. The information on media source of an auxiliary content is an identification of an auxiliary content item if the item is created in separation from a main source according to one of the methods illustrated in FIGS. 4A to 4D. Otherwise, the information on media source is a URL. The former is called ‘indirect linking’ while the latter is called ‘direct linking’. A new attribute ‘Mandatory’ is defined in a resource tag reserved for each media source of an auxiliary content and a value TRUE or FALSE is written in the attribute ‘Mandatory’ 451c. The attribute ‘Mandatory’ is used to indicate that a media source whose attribute ‘Mandatory’ is set to TRUE is regarded as ‘selected’ for synchronous presentation with a main content if there is no selection among a plurality of media sources of an auxiliary content from a user.

Information on media source combinations of a main content and an auxiliary content that can be synchronously presented may be written in a tag <relationship> within the expression information tag 451a, and information on linking structure between a main content and an auxiliary content may be written in a tag <structure>. In addition, a variety of information needed for synchronous presentation of a main content and an auxiliary content may be defined in the expression information tag 451a and be then used.

After item information about stored media sources has been created according to the above methods or one of the above methods, as shown in FIG. 3, information about each item is delivered from the CDS 221 to the CP 210 by a browsing action or search action of the CP 210 (S30). As a matter of course, before invoking such an action, as shown in FIG. 3, the CP 210 requests acceptable protocol information on a media renderer 230, thereby obtaining the protocol information beforehand (S01).

The CP 210, from information of objects received at S30 step, provides the user only with those objects (items) having protocol information accepted by the media renderer 230 through a relevant UI (User Interface) (S31-1). At this time, an item whose class is “object.item.subtitle” is not exposed to the user. In another embodiment according to the present invention, an item of type “object.item.subtitle” is displayed to the user with a lighter color than those of items of other classes, thereby being differentiated from the others.

Meanwhile, the user selects, from a list of the provided objects, an item corresponding to a content to be presented through the media renderer 230 (S31-2). If meta data of the selected item contains information indicating that the selected item is associated with an auxiliary content (a tag <IDPointer> or <expression> contains information on other item or media source in the above-explained embodiments), the CP 210 conducts the following operations for synchronous presentation of a media source of the selected item and a media source or media sources of an associated auxiliary content. If there are a plurality of auxiliary content items for caption associated with the selected item or if an auxiliary content is for a plurality of caption groups, the CP 210 provides the user with a selection window for caption language. Detailed operations will be explained afterward.

The CP 210 identifies an item of an associated auxiliary content based on information stored in the meta data of the selected item and issues connection preparation actions “PrepareForConnection( )” to both the media server 220 and media renderer 230 respectively for the identified auxiliary content item as well as the selected item (S32-1, 532-2). The example of FIG. 3 is depicted on the assumption that a single item of auxiliary content is associated with a main content. Therefore, the connection preparation action is issued twice to each of the devices 220 and 230 for two sources. If the number of auxiliary content items is N (for example, a case that a slidshow content as well as a caption content pertains to an auxiliary content) or the number of media sources indicated by a single auxiliary content item is N as in the embodiment of FIG. 4D, the connection preparation action would be issued N+1 times to each device for media sources including a main content. In response to the issued action, the CP 210 receives instance ID of service elements (CM: ConnectionManager Service, AVT: AVTransport Service, RCS: RenderingControl Service) to participate in presentation through streaming between the devices 220 and 230 (S32-1, S32-2). The instance ID is used to identify and control streaming service to be conducted later. The CP 210 sets source information of the selected item and the auxiliary content item associated therewith to an AVTransport service 233 (The AVTransport service is embodied in the media renderer 230 in the example of FIG. 3, however, it may be embodied in the media server 220.) through respective URI setting actions “SetAVTransportURI( )” (S33). After such settings, an operation to verify whether presentation of the auxiliary content is actually possible may be conducted. For example, whether size of a caption data file and a character set stored therein can be supported may be checked. If not supported, the media renderer 230 sends a response of failure for the issued action. If response to the URI setting action “SetAVTransportURI( )” is successful, the CP 210 issues respective play actions to the AVTransport service 233 for each of the media sources (S34). Accordingly, data of the selected main content and the auxiliary content associated therewith is streamed (The auxiliary content may be transferred not in streaming manner but in downloading manner.) to an RCS 231 (S35) after appropriate information communication between the media renderer 230 and the media server 220. The data being streamed (and/or pre-fetched data of the auxiliary content) is rendered by adequate decoders, controlled by the RCS 231, to achieve synchronous presentation.

Meanwhile, the RCS 231 defines and uses state variables illustrated in FIG. 6 to support presentation of caption data. Explaining the defined state variables in more detail, a state variable ‘SubtitleLanguageList’ is a list to store information indicating caption languages that are supported by the RCS 231, and a state variable ‘CharacterSetList’ is a list to store information indicating character sets that are supportable (namely, character codes of each supportable set can be displayed as a corresponding character) by the RCS 231. The initial values of said both state variables are defined when designing the RCS 231 and afterward, the values of said both state variables are changed (or a new value is added) or queried by the CP 210 through a state variable setting action “SetStateVariables( )” or a state variable query action “GetStateVariables( )”.

A state variable ‘CurrentSubtitleLanguage’ is used to indicate a caption language that is currently rendered by the RCS 231 and another state variable ‘CurrentCharacterSet’ is used to indicate a character set that is currently used by the RCS 231 in rendering for caption display. That is, said both state variables ‘CurrentSubtitleLanguage’ and ‘CurrentCharacterSet’ are respectively set to values of the attributes ‘language’ and ‘character-set’ in the resource tag of meta data of the auxiliary content item (the content item in case of the embodiment of FIG. 4E) being streamed or downloaded according to the play action of FIG. 3.

If change of caption language is requested from a user during synchronous presentation of a content and caption thereof, the CP 210 searches for an item of a media file storing caption data corresponding to new caption language, and issues to the media renderer 230 a connection preparation action, a URI setting action and a play action sequentially for a media source of the found item. As a result, caption of the new language is presented synchronously and values of the state variables ‘CurrentSubtitleLanguage’ and ‘CurrentCharacterSet’ are changed. If media data of the newly selected caption language from the user has been already contained in the same media source of the caption data that is being displayed, namely if the media data of the newly selected caption language is already being streamed to the media renderer 230 or has been already pre-fetched in the media renderer 230, the CP 210 only issues a state variable setting action to request the RCS 231 to set the state variables ‘CurrentSubtitleLanguage’ and ‘CurrentCharacterSet’ to adequate values for the newly selected caption language. After setting of the state variables, the RCS 231 starts to render caption data of the new language.

The state variable ‘Subtitle’ is used to store a value indicate whether the RCS 231 displays captions or not. If the state variable ‘Subtitle’ is set to ‘OFF’ the RCS 231 does not conduct rendering for displaying captions although an auxiliary content for captions is received to the RCS 231 according to the above-explained method. The state variable ‘Subtitle’ can be changed to other value by the state variable setting action “SetStateVariables( )” and its current value can be known by the state variable query action “GetStateVariables( )”.

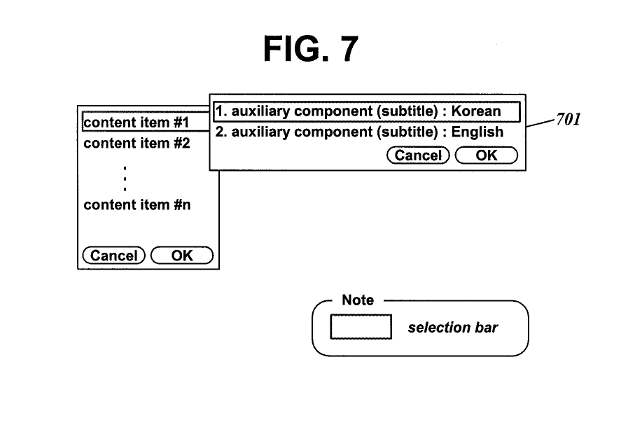

In the meantime, if a main content item is selected as mentioned above in the step S31-2 of the CP 210 for selecting a content to be played, the CP 210 searches for an auxiliary content associated with the selected item based on information written in meta data of the selected item. If a found auxiliary item is for caption the CP 210 checks what languages can be presented in caption and provides a user with a selection window 701 including a list of presentable languages as illustrated in FIG. 7. Then, the user selects one language from the list.

For example, the CP 210 knows the presentable languages from a code or codes specified by an attribute, i.e., ‘language’ of a resource tag of an item pointed by information written in the tag <IDPointer> in the embodiments of FIGS. 4A and 4D. The presentable languages can be known from a code or codes specified by an attribute, i.e., ‘SubtitleLanguage’ of a resource tag of a selected item in the embodiment of FIG. 4E. The presentable languages can be known from an attribute of a resource tag of an item pointed by information written in a resource tag within the tag <component> within the tag <expression> (in case of ‘indirect-linking’), or from a code or codes specified by an attribute of a resource tag within the tag <component> within the tag <expression> (in case of ‘direct-linking’) in the embodiment of FIG. 4F.

If one language is chosen from the selection window 701, the procedures for providing the media renderer 230 with a media source comprising caption data of the chosen language together with a selected content item are conducted according to the method explained above.

The present invention described through a limited number of embodiments above, in case that data can be transferred and presented between interconnected devices through a network, automatically provides an auxiliary content to be played in synchronization with a selected content after searching for the auxiliary content associated with the selected content. Accordingly, it can be more convenient to manipulate a device for playing a content and the user's feeling of satisfaction about watching or listening to the content can be enriched through an auxiliary component.

The foregoing description of a preferred embodiment of the present invention has been presented for purposes of illustration. Thus, those skilled in the art may utilize the invention and various embodiments with improvements, modifications, substitutions, or additions within the spirit and scope of the invention as defined by the following appended claims.

1. A method for preparing meta data about stored content, comprising:
creating meta data including protocol information and access location information about an arbitrary content;
creating an item of an auxiliary content to be presented in synchronization with the arbitrary content and writing information on text data of the auxiliary content in the created item; and
incorporating identification information of the created item into the meta data.

2. The method of claim 1, wherein the item creating step creates a plurality of items for an auxiliary content to be presented in synchronization with the arbitrary content, and the incorporating step incorporates identification information of each of the plurality of items into the meta data.

3. The method of claim 2, wherein the text data is language data, and the item creating step creates the plurality of items such that the plurality of items are associated with media sources that contain data of mutually different languages.

4. The method of claim 1, wherein the text data is language data, and the item creating step creates the item such that a single item is associated with a single media source containing data of a plurality of languages.

5. The method of claim 1, wherein the text data is language data, and the item creating step creates the item such that a single item is associated with a plurality of media sources that are all needed for presenting caption of a single language.

6. The method of claim 1, wherein the information on text data comprises information indicating a language displayed during playing, and character code information indicating a character set being used for displaying a language.

7. The method of claim 1, further comprising
writing in the meta data information indicating that a particular media source is regarded as selected if there is no selection by a user from among a plurality of media sources, in a case that the auxiliary content consists of the plurality of media sources to support a plurality of languages respectively.

8. The method of claim 1, wherein the incorporating step incorporates the identification information into a tag different from another tag which the protocol information and the access location information are written in.

9. The method of claim 1, wherein the item creating step writes the information on text data as an attribute of a tag within the created item which protocol information and access location information are written in.

10. A method for preparing meta data about stored content, comprising:
creating meta data including protocol information and access location information about an arbitrary content whose attribute is video and/or audio; and
writing in the meta data information on language of text data included in the arbitrary content.

11. The method of claim 10, wherein the information on language of text data comprises information indicating a language displayed during playing, and character code information indicating a character set being used for displaying a language.

12. The method of claim 10, wherein the writing step writes the information on language of text data as an attribute of a tag which the protocol information and the access location information are written in.

13. An apparatus for making presentation of a content, comprising:
a server storing at least one main content and at least one item corresponding to an auxiliary content that is to be presented in synchronization with the main content;
a renderer for making presentation of the main content and the auxiliary content provided from the server,
wherein the renderer includes a first state variable for
storing language information of text data to be presented when the text data contained in the auxiliary content is presented.

14. The apparatus of claim 13, wherein the first state variable comprises a state variable indicating a language displayed during presentation of text data, and another state variable indicating a character set being used for displaying a language.

15. The apparatus of claim 13, wherein the renderer further includes a second state variable for storing a list of text data of which rendering is possible.

16. The apparatus of claim 13, wherein the renderer further includes a third state variable for indicating whether or not to present text data pertaining to the auxiliary content.

17. The apparatus of claim 13, wherein a value of the first state variable can be changed by a state variable setting action received from outside, and the value can be queried by a state variable query action received from outside.

18. The apparatus of claim 13, wherein meta data of the main content comprises protocol information and access location information of the main content, and identification information of the at least one item.

19. The apparatus of claim 18, wherein the identification information is written in a tag different from another tag which the protocol information and the access location information are written in.
